(19) United States
(12) Patent Application Publication
(10) Pub. No.: US 2006/0234199 A1
(43) Pub. Date: Oct. 19, 2006

(54) Computer-based system and method for developing memory skills

(76) Inventors: James Walker, Plymouth Meeting, PA (US); Mark LoSasso, Drexel Hill, PA (US)

Correspondence Address: McCARTER & ENGLISH, LLP;Attn: Angelica Brooks, CityPlace I, 185 Asylum Street, Hartford, CT, 06103, US

(21) Appl. No.: 11/324,397

(22) Filed: Jan. 3, 2006

Related U.S. Application Data
(60) Provisional application No. 60/641,112, filed on Jan. 3, 2005.

(51) Int. Cl. G09B 7/00

(52) U.S. Cl. 434/323; 434/236

(57) ABSTRACT

A system and method for assisting individuals in developing and refining memory skills is disclosed. The computer-based system and method provide users with one or more images or landscapes for placement of information kernels for memory enhancing purposes. Among the features and functionalities associated with the computer-based system and method are: (i) pre-prepared images and landscapes for use in placement of information kernels, (ii) automatic reminder communications to facilitate development of memory skills, (iii) testing and scoring tools, and (iv) network-based sharing capabilities that permit a system user to provide and access images and landscapes on a shared basis.

### BACKGROUND

1. Cross-Reference to Related Applications

The present application claims the benefit of a provisional application entitled “System and Method for Developing Memory Skills,” which was filed on Jan. 3, 2005, and assigned Ser. No. 60/641,112. The entire contents of the foregoing provisional application, including without limitation Exhibits A-D thereto, are hereby incorporated by reference.

2. Technical Field The present disclosure is directed to a system and method for assisting individuals in developing and/or refining memory skills and, more particularly, to a computer-based system/method that provides users with one or more images/landscapes for placement of information kernels for memory enhancing purposes. Exemplary embodiments of the present disclosure include one or more of the following features/functionalities: (i) pre-prepared images/landscapes for use in placement of information kernels, (ii) automatic reminder communication(s) to facilitate development of memory skills, (iii) testing and/or scoring tools, and/or (iv) network-based sharing capabilities that permit a system user to provide and/or access images/landscapes on a shared basis.

3. Background Art

Memory skills are of general importance in day-to-day life and it is not uncommon for individuals to seek ways to improve their memory. Basis memory games are often used with youngsters to enhance memory skills, e.g., conventional “matching” games aimed at pairing like items and/or remembering the sequence of various events or stimuli. Additional efforts in the field of memory development and/or memory testing are reflected in the patent literature. Illustrative prior art teachings include the following:

U.S. Pat. No. 6,769,918 to God entitled “Tutorial System for Learning Training Contents, Learning Programme Logic,” wherein a learning system/method are provided for visually displaying learning contents stored on a memory onto a display for facilitating easy learning by humans. The learning system/method causes a visual presentation to be displayed on a display screen for a predetermined period of time, e.g., less than 0.2 second. The learning contents can be introduced at changing locations in a region of the visual presentation on the display screen.

U.S. Pat. No. 6,689,058 to Buschke entitled “Memory Tests Using Item-Specific Weighted Memory Measurements and Uses Thereof,” wherein a method for increasing the usefulness, sensitivity and specificity of tests that measure memory and facets of memory is provided. According to the Buschke '058 patent, the sensitivity and specificity of such tests are enhanced by selectively weighting the value of specific items recalled by the test subject, either by weighting such items within any specific testing trial or across numerous testing trials. The Buschke '058 patent provides tests that employ item-specific weighting for the diagnosis of Alzheimer's Disease and other dementia characterized by memory impairment, as well as a method of screening for and evaluating the efficacy of potential therapeutics directed to the treatment of such dementia.

U.S. Pat. No. 6,685,482 to Hopp et al. entitled “Method and System for Creating and Evaluating Quizzes,” wherein software is disclosed that uses a computer and a data storage system to provide a quiz module database. The quiz module database is maintained by a software module database management system, containing at least one quiz module, and a structured learning material editor module database, maintained by a software module database management system and containing at least one structured learning material editor modules. The software also has a structured learning material database, maintained by the user database management system, for storing at least one structured learning material data set created by a user. A user interface is provided for selecting system control functions, editing structured learning materials, presenting quizzes, receiving user answers to quizzes, and displaying quiz analysis results. A control system retrieves software modules from the software module database management system and activates them.

U.S. Pat. No. 5,494,444 to Thayer et al., entitled “Method of Simulating Flashcards for Learning Purposes,” wherein a method is provided for displaying information for learning purposes, the method including the steps of providing within a computer an information set having at least a first information topic. The first information topic includes a plurality of discrete information elements. The discrete information elements are caused to be arranged for display within the computer in a sequence selected from a plurality of predetermined sequences. The discrete information elements are displayed with a display operably associated with the computer in the selected sequence.

U.S. Patent Publication No. 20030009461 to Notargiacomo et al., entitled “Method and System for Capturing Memories of Diseased Individuals,” wherein a method, system, and computer software product are provided for capturing and distributing memories of a deceased individual. An electronic storage memory database is provided having controls for allowing selective entry of information into the database with respect to a selected individual. Individuals can be pre-authorized to access the database for viewing or entering of data into the database with respect to a deceased individual. Also, a gatekeeper can be designated for providing editorial control over entry of data.

U.S. Patent Publication No. 20020111201 to Lang, entitled “Location-Based Game System,” wherein a location-based game system is provided for players over a wide region that uses location information transmitted from their wireless devices to a wide area computer network. Information from the wide area computer network can be downloaded to other players to determine the physical location of the players participating in the game. The location-based game system includes a location-based game software program preferably loaded into the memory of a central computer coupled to the wide area computer network that controls the game and monitors the action and location of the players. During the game, data from each wireless device is uploaded to a player databank on the central computer. Other players or authorized viewers are able to log onto the central computer to review the game status information that may include the user's location information in his or her database.

U.S. Patent Publication No. 20030165800 to Shaw et al. entitled “Method and System for Teaching Vocabulary,” wherein a method is provided that uses a spatial-temporal software game for both teaching math concepts to a child and for scoring the child's proficiency in these math concepts. These scores are compared with the child's performance on a language-based test of the math concepts. If the child's score on the language-based test is lower than what is reflected by the child's game scores, instruction is given the child using stories and flashcards related to the spatial-temporal software games so that the child will relate vocabulary terms with the math concepts and characters in the temporal-spatial software game.

U.S. Patent Publication No. 20030076352 to Uhlig et al. entitled “Note Taking, Organizing and Studying Software,” wherein a note taking program is provided which allows a user to take notes on an electronic note card from content being read. The note card includes a list of keywords, a list of links to related material, and a field of associated material in addition to a note text field. The note cards are contained in groups and each group of note cards can contain note card stacks. The program allows for searching of the note cards and displaying of the note cards in various formats to facilitate review and organization of the note cards. Additionally, note cards can be enabled to be viewed as flashcards.

U.S. Patent Publication No. 20040157193 to Mejias et al. entitled “Computer-Aided Design and Production of an Online Learning Course,” wherein a computer-aided method for designing and producing an online course is described. An electronic online course structure is generated using one or more clusters of learning objects corresponding to learning molecules. Each learning molecule defines a course topic around which a learning experience is organized. An XML course structure document is generated from an electronic online course overview. During an initial phase of development, one or more directories of placeholder course web pages are automatically generated to mirror the course structure defined in the course structure document. Each placeholder course web page corresponds to one of the learning objects associated with each learning molecule. During a second phase of development, course content is produced for each learning object and learning objects are embedded into the placeholder web pages. Web page properties are defined for each course web page. Navigational hyperlinks are created between the course web pages based on the hierarchy described in the course structure document. The web pages are compiled into a finished web-based online course and provided as a software product or sent to an online course deployment server.

U.S. Patent Publication No. 20020180770 to Sirhall entitled “Software Tool for Creating an Interactive Image Drag Drop,” wherein an interactive software tool is provided for testing a user in a web-based learning environment. The interactive software tool is embedded in a course page of a web-based curriculum. The software tool provides a question to a user regarding the information presented in the course, and an answer box containing a plurality of correct and incorrect answers. The software tool instructs the user to select at least one answer to the question. The software tool provides feedback to the user, and allows the user to revise an incorrect answer selection.

U.S. Patent Publication No. 20040230951 to Scandura entitled “Method for Building Highly Adaptive Instruction Based on the Structure as Opposed to the Semantics of Knowledge Representations,” wherein a method is provided for authoring and delivering highly adaptive instructional systems based on abstract syntax tree representations of the problems to be solved by learners and of the requisite knowledge structures to be acquired. Authoring includes: (a) receiving and/or constructing abstract syntax tree representations of essentially any kind of to-be-acquired knowledge, (b) methods for representing problem schemas in an observable medium enabling communication between tutors and learners, and (c) configuring the learning and tutorial environment to achieve desired learning. Delivery includes general-purpose methods for generating specific problems, updating the learner model, and sequencing diagnosis and instruction.

Beyond the patent literature, additional memory-related texts have been published, including: (i) “The Memory Palace of Matteo Ricci” by Jonathan Spence, (ii) “Logic and the Art of Memory” by Paolo Rossi, (iii) “In the Palaces of Memory” by George Johnson, (iv) “Chambers for a Memory Palace” by Donlyn Lyndon, and (v) “The Art of Memory” by Francis Yates.

Despite the teachings and developments to date, a need remains for systems and methods that enhance memory development and/or memory skills. In addition, a need remains for systems and methods that enhance memory development and/or memory skills that are network-based and that facilitate sharing of images/landscapes and the information/files related to utilization of the disclosed systems/methods. Still further, a need remains for systems and methods that promote usage and that measure performance.

These and other needs are met by the disclosed systems and methods, as set forth in the description which follows, particularly when view in conjunction with the appended figures.

### SUMMARY OF THE PRESENT DISCLOSURE

The present disclosure provides an advantageous system and method for assisting individuals in developing and/or refining memory skills. The disclosed system/method is generally implemented using a computer system, e.g., a system that includes processing capabilities (e.g., a processor), computer memory in communication with the processor, and a data entry interface (e.g., a keyboard). The computer system may be adapted for communication across or with a computer network, e.g., an intranet, extranet, the World Wide Web or other Internet-based network(s). The disclosed system and method generally provide users with the ability to use one or more images/landscapes for placement of information kernels for memory enhancing purposes. The placement of the information kernels on the image/landscape may be predetermined for a particular image/landscape, but is generally repositionable by the system user. Alternatively, placement of individual information kernels relative to an image/landscape is controlled by a system user in the first instance.

Exemplary embodiments of the present disclosure include one or more of the following features/functionalities: (i) pre-prepared images/landscapes for use in placement of information kernels, (ii) automatic reminder communication(s) to facilitate development of memory skills, (iii) testing and/or scoring tools, and/or (iv) network-based sharing capabilities that permit a system user to provide and/or access images/landscapes on a shared basis.

The pre-prepared images/landscapes may take a multitude of forms, e.g., the interior rooms/layouts of buildings or other structures (e.g., cars, trains, planes, etc.), distinctive landscapes (e.g., beaches, forests, historical sites, and the like), collections of individuals (e.g., family portraits, sports teams, groupings of friends, etc.), and other animate or inanimate objects or things. In addition to (or instead of) the foregoing pre-prepared images/landscapes, the disclosed system/method advantageously accommodates input of images/landscapes that may be selected by a system user. Thus, for example, a system user may upload/input digital images that are created/captured by the system user and/or images that are accessed over a network, e.g., digital images available over the Internet. In a further exemplary embodiment of the present disclosure, system users may supply digital images/landscapes to a centralized location associated with the disclosed system, e.g., a “sharing library,” and such supplied images/landscapes may be accessed and utilized by other system users in connection with their respective memory-enhancing activities. According to exemplary embodiments of the present disclosure, various forms of consideration (e.g., payments) may be associated with the supply of image(s)/landscape(s) to a centralized location by a system user, such payments being driven by the supply of the image/landscape, the use of the supplied image/landscape by another system user, or combinations thereof.

Automatic reminder communications may be directed to a system user in a number of ways. According to exemplary embodiments of the present disclosure, one or more reminder communications are transmitted to a system user on a predetermined periodic basis, such communications encouraging/prompting the system user to revisit an image/landscape for memory training and/or testing purposes. The predetermined periodic basis may be, for example, one day after initial creation of an information kernel-containing image/landscape, three days after initial creation thereof, seven days after initial creation thereof, and fourteen days after initial creation. Communications are generally effectuated through electronic means, e.g., via e-mail and/or by posting reminder information at a personalized webpage hosted at a website associated with the disclosed system/method. Of note, exemplary e-mail communications may contain relevant reminder/prompting information or may direct the system user to visit a personalized webpage to access relevant reminder information (e.g., via a hyperlink embedded in the e-mail communication). In exemplary embodiments of the personalized webpage, appropriate reminder information may first appear at the webpage when the predetermined period has expired (e.g., after one day, three days, etc.) or may “count-down” to the relevant predetermined period (e.g., one day until next scheduled follow-up, twelve hours until next scheduled follow-up, etc.).

Thus, according to exemplary embodiments of the present disclosure, user milestone dates may be stored on a central server and system users are provided with access to such milestone dates over a network, e.g., the Internet. Additionally, in exemplary embodiments, system users receive periodic “push” messages from the server, e.g., via email, telephone or the like. The messages typically remind the system user that it is time to review a particular populated image/landscape, complete a memory test, or take other action with respect to the disclosed system/method. In alternative exemplary embodiments of the present disclosure, downloaded versions of the disclosed system/software incorporate a desktop-based functionality/service that tracks system user's milestones, i.e., in a closed (non-networked) manner. According to exemplary embodiments of the downloaded/local versions of the disclosed system/software, milestone dates/reminders automatically appear on a system user's screen, e.g., on the left hand side of an initial screen encountered by system users when they open the software. Relevant data associated with milestone dates/reminder algorithms for such downloaded versions are generally stored on the system user's hard drive. Thus, the disclosed system/method advantageously supports/enables alternative “reminder” functionalities, wherein system users may have their memory milestones tracked on a central database/server with reminders sent over a network, e.g., the Internet, and/or system users may have their memory milestones tracked locally, i.e., on their own computer/hard drive, with appropriate reminders automatically posted when the system user opens his/her downloaded software/application.

Testing and/or scoring functionalities are advantageously associated with the disclosed system/method. Thus, according to exemplary embodiments of the present disclosure, information kernels are associated with selected aspects/features of a landscape/image (e.g., presidents, state capitals, birthdates, etc.) and, after review/study, a system user is tested as to the information kernels. For example, a landscape/image may be populated with ten (10) information kernels and the testing procedure may give the system user an opportunity to demonstrate memorization of the ten items. Of note, the testing process may be timed, with a higher score being awarded based on the speed with which the test is completed. In addition, according to exemplary embodiments of the present disclosure, the scoring functionality includes a scoring algorithm that awards a higher score for correct responses based upon the length of time from the date of creation of the information kernel-populated image/landscape, i.e., a higher score is awarded for eight correct responses on a test date one week after the populated image/landscape is created, as compared to eight correct responses on the day after population of the image/landscape. A system user's scores are advantageously retained and may be integrated with the performance of other system users, e.g., as part of a competitive and/or comparative implementation of the disclosed system/method.

In populating an image/landscape according to the present disclosure, it is generally advantageous for a system user to personalize the “memory story.” Whether a system user is working with an image/landscape developed by a third party, e.g., an image/landscape provided with the disclosed software and/or a downloaded image/landscape from a library thereof, or building/inputting a unique image/landscape, e.g., a digitized photo or the like, a key to making lasting memories is to personalize the populated image/landscape. Thus, for example, the disclosed system/method generally permits a system user to change the location and/or story for each memory object, the images for each room, and/or even the floor-plan of the entire image/landscape, e.g., by adding or removing rooms.

For existing images/landscapes, according to exemplary embodiments of the present disclosure, a system user can easily move between “Review” and “Edit” modes e.g., by clicking on an Edit button on a navigation bar. In general, most editing involves the memory stories associated with each item. This aspect of system utilization generally provides a system user with the opportunity to put his/her imagination to work by creating a short and descriptive story that will burn a strong image into the mind's eye of the system user. Sometimes an existing memory story will really jump to life for a system user-if so, that's great-no editing is needed. But if the story doesn't work is not optimal, a system user has the ability to create/write his/her own story. Either way, once a system user has a visually strong story associated with each particular memory item, the room and floor-plan metaphor of the disclosed system/software provides a powerful framework for a system user to step sequentially from one imaginative story to the next.

Of note, in the current media-saturated world, it may take practice for a system user to call his/her own images into mind, but the habit of creating imaginative pictures in the mind's eye of a system user will radically transform his/her memory power. In this sense, the memory stories should be brief descriptive sketches of much more elaborate images that the system user can see inside his/her mind's eye. Once a system user is satisfied with his/her stories, it is generally appropriate to switch back into “Review” mode, e.g., to see if any of the memory items are not sticking in the system user's memory. If so, the disclosed system/software allows the system user to again return to “Edit” mode to change those memory stories, e.g., by moving the location of a memory object to a different location in the room. Typically, after two or three days into the review cycle, the stories of a system user will not require further editing-and the system user will be well on the way to building unforgettable memories.

Additional advantageous features and functionalities of the disclosed system and method will be apparent from the detailed description which follows, particularly when reviewed together with the figures appended hereto.

### BRIEF DESCRIPTION OF THE FIGURES

To assist those of ordinary skill in the art in implementing and using the disclosed system and method for assisting individuals in developing and/or refining memory skills, reference is made to the appended figures, wherein:

FIG. 1 is a view of an exemplary screen view according to an implementation of the present disclosure;

FIG. 2 is a view of an exemplary screen view associated with an authoring mode according to the present disclosure;

FIG. 3 is a view of an exemplary screen view associated with accessing a first “Mind Palace” (Top 30 Movies) according to the present disclosure;

FIG. 4 is a view of an exemplary screen view associated with the exemplary “Top 30 Movies” Palace of FIG. 3 according to the present disclosure;

FIG. 5 is a view of an exemplary screen view associated with an illustrative floor-plan associated with a “Top 30 Movies” Palace according to the present disclosure;

FIG. 6 is a view of an exemplary screen view associated with customization of an exemplary “Top 30 Movies” Palace according to the present disclosure;

FIG. 7 is a view of an exemplary screen view in authoring mode associated with an illustrative room-plan associated with a “Top 30 Movies” Palace according to the present disclosure;

FIG. 8 is a view of an exemplary screen view similar to the screen view of FIG. 7, but no longer in authoring mode;

FIG. 9 is a view of an exemplary screen view similar to FIG. 8, but with a “Memory Object List” visible thereon;

FIG. 10 is a view of an exemplary screen view with objects removed from the room-plan of FIGS. 7-9;

FIG. 11 is a view of test screen according to the present disclosure; and

FIG. 12 is a view of an exemplary completed test screen according to the present disclosure.

### DESCRIPTION OF EXEMPLARY EMBODIMENT(S)

As noted above, the present disclosure provides an advantageous system and method for assisting individuals in developing and/or refining memory skills. The disclosed system/method offers a flexible, versatile and engaging/entertaining modality for improving memory-related capabilities. Exemplary embodiments of the disclosed system may be hosted by one or more servers that are accessible over a network, e.g., the Internet, or may be downloaded for local use, e.g., on a personal computer or the like. Alternatively, the disclosed system may be distributed through conventional retail outlets, e.g., on CDs/DVDs or the like. Updated versions of the disclosed system may be distributed/delivered to system users on a periodic basis, as is generally known in the art for computer-based systems, programs and applications.

Thus, according to exemplary embodiments of the present disclosure, the system/method is implemented using a computer system. The computer system typically includes a processing unit, e.g., a CPU or other processing modality. The disclosed system/method is generally embodied in software that is operable by the processing unit, as is well known in the art. The software is generally stored in computer memory that is in communication with the processor. The disclosed computer program generally makes further use of the computer memory, e.g., by storing data/information related to a system user's interaction/use of the disclosed program. Thus, for example, previously populated images/landscapes, test scores and the like, are generally stored in computer memory and accessed by the processor/program on an as-needed basis. A data entry interface is generally provided, e.g., a keyboard, for interacting with the CPU and operating the software program.

Exemplary systems according to the present disclosure have the following technical specifications and related interactivity:

Operating System: Microsoft® Windows® 98, 2000, NT®, and XP.

RAM: 128 Mb and higher.

Available Disk Space: 4 Mb minimum.

Display Resolution: 800 x 600 minimum.

Supported File Formats: JPEG, SWF.

The computer system may be adapted for communication across or with a computer network, e.g., an intranet, extranet, the World Wide Web or other Internet-based network(s). Thus, the computer program associated with the disclosed system/method may be accessed across a network and downloaded to a remote location, e.g., a system user's personal computer, pursuant to applicable “terms of use,” e.g., based on an appropriate credit card authorization or the like. The disclosed system and method generally provide users with the ability to use one or more images/landscapes for placement of information kernels for memory enhancing purposes. The placement of the information kernels on the image/landscape may be predetermined for a particular image/landscape, at least initially. However, the information kernels are generally repositionable by the system user, e.g., based on “drag-and-drop” functionality. Alternatively, placement of individual information kernels relative to an image/landscape may be controlled by a system user in the first instance, i.e., a cursor may be employed for demarcation of a desired location.

Exemplary embodiments of the present disclosure include one or more of the following features/functionalities: (i) pre-prepared images/landscapes for use in placement of information kernels, (ii) automatic reminder communication(s) to facilitate development of memory skills, (iii) testing and/or scoring tools, and/or (iv) network-based sharing capabilities that permit a system user to provide and/or access images/landscapes on a shared basis. Additional features and functionalities of the disclosed system and method will be apparent from a description of an exemplary embodiment thereof, with reference to the appended figures and appendices. However, the present disclosure is not limited to the exemplary embodiments described herein, but rather embraces alternative implementations that embody the advantageous and innovative aspects and/or functionalities thereof.

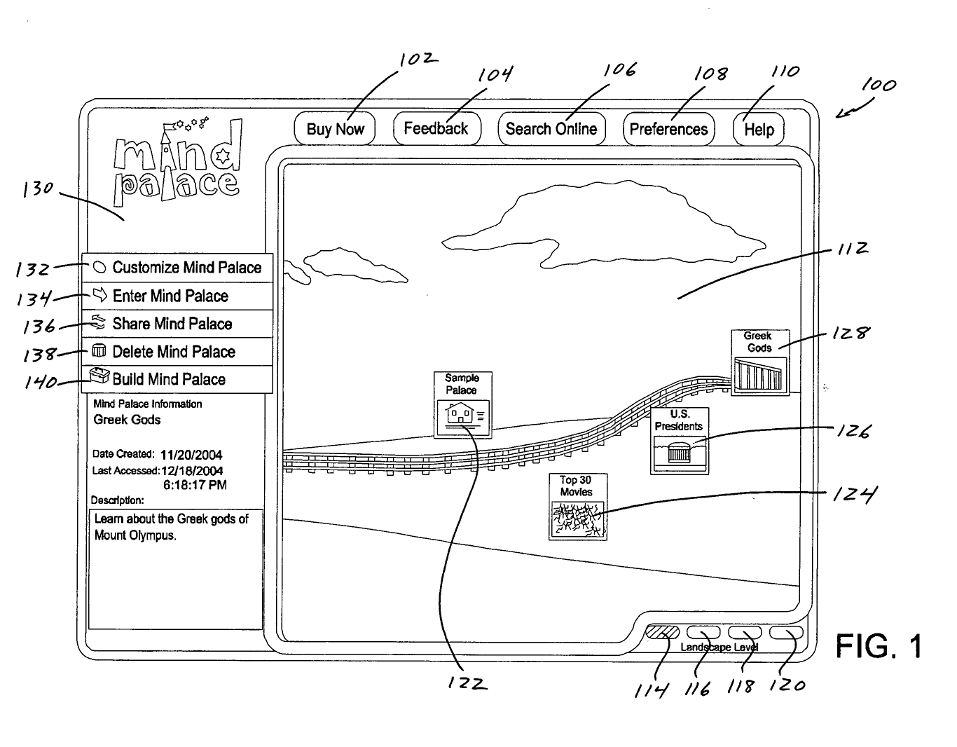

With reference to FIG. 1, a screen view 100 for an exemplary implementation of the disclosed system/method is depicted. The exemplary screen view of FIG. 1 includes four navigational regions. Along the upper edge are five exemplary links, as follows:

Buy Now link 102: A link that accesses subscription/purchase options and/or ancillary commercial functionalities (e.g., links to affiliated commercial sites).

Feedback link 104: A link that provides communication link(s) to the creator/manufacturer or other authorized individual/entity for providing feedback and/or questions/concerns related to the disclosed system/method. The communication link(s) may be electronic (e.g., e-mail), telephonic, by facsimile, conventional mail or combinations thereof.

Search Online link 106: Provides access to additional images/landscapes, e.g., from a library of images/landscapes that is maintained at a central server or other network- accessible location associated with the disclosed system/method. The images/landscapes that may be accessed via the “Search Online” link may be pre-populated with information kernels, as described herein, and/or may provide pre-designated locations for entry of information kernels, i.e., “hot spots.” Of note, utilization of the images/landscapes accessible through the “Search Online” functionality may entail a subscription fee, a “pay-per-use” fee, or other form of consideration. Accounting functionality may be associated with the images/landscapes accessible from the library, such that a creator of an image/landscape earns a “commission” or other form of payment in connection with usage of such image/landscape by another system user. Thus, an earn-out functionality serves as an incentive for system users to contribute images/landscapes to a centralized library, thereby enhancing the breadth/depth of the overall system.

Preferences link 108: Provides access to functionality for setting personal preferences, e.g., audio preferences, visual preferences and the like. Thus, for example, the background image in FIG. 1 (farm/prairie image 112) may be reset/redefined using the Preferences link. Additional personal preferences may be accommodated, as will be readily apparent to persons skilled in the art.

Help link 110: Provides a link to conventional “help” messages.

Additional navigational links are located along the bottom edge of the exemplary screen view of FIG. 1 (i.e., elliptical buttons 114, 116, 118, 120). The four elliptical buttons 114-120 are provided for navigating with respect to “levels” of the disclosed system/method. Thus, according to the exemplary embodiment depicted in FIG. 1, the left-most elliptical button 114 corresponds to the first “level” of the disclosed system, i.e., the level depicted in FIG. 1. The elliptical button to the right of this first elliptical button, i.e., button 116, corresponds to the second level of the disclosed system. Button 118 corresponds to the third level of the disclosed system, and button 120 corresponds to the fourth level of the disclosed system.

In the exemplary embodiment described herein, four levels are contemplated. However, the present disclosure is not limited to implementations that encompass four levels (and four corresponding navigational buttons); rather, the present disclosure embraces and encompasses alternative implementations with different numbers of levels (and corresponding numbers of navigational links), as will be readily apparent to persons skilled in the art from the detailed description provided herein.

With reference to the landscaped background image 112 of FIG. 1, the exemplary embodiment disclosed herein features a farm/prairie. This landscaped image 112 is non-functional for purposes of the present disclosure (much like a screen saver) and may be changed, as desired, by a system user. A plurality of links 122, 124, 126, 128 (in the form of substantially rectangular icons according to the exemplary embodiment of FIG. 1) are positioned on the landscaped image 112. Each of the links 122, 124, 126, 128 is associated with an image/landscape for use in the disclosed memory-enhancing and/or memory-refining functionalities of the present disclosure. The disclosed links (Sample Palace link 122, Top 30 Movies link 124, U.S. Presidents link 126, and Greek Gods link 128) are merely exemplary of potential informational categories that may be the subject of populated images/landscapes according to the present disclosure. Similarly, the thumb-nail images associated with the foregoing links are merely illustrative. Of note, the thumb-nail images generally correspond to larger images/landscapes that are reached by way of the associated link, i.e., at succeeding levels of the disclosed system/method, as will be apparent from the detailed description which follows.

With reference to the left-most portion 130 of FIG. 1, additional navigational links 132, 134, 136, 138, 140 associated with use of and/or interaction with the disclosed system/method are provided. Each of these additional navigational links is discussed in turn. For purposes of the following discussion, a partial glossary of terms is provided herein.

### GLOSSARY OF TERMS

Authoring Mode: The authoring mode of the disclosed system/method is where a system user has the ability to build or customize an existing image/landscape, including its palace view, floor-plan, rooms and/or memory objects.
Floor-plan: The floor-plan of a “Mind Palace” shows the layout of each of the rooms available in that “Mind Palace” and also serves as a menu through which a user can enter each room.
Image/Landscape: An image/landscape is where information kernels reside. A system user can enter each individual image/landscape from the “landscape view.”
Memory List: A memory list is a list of items (memory objects) that a system user wants to memorize.
Memory Milestones: In order to memorize each memory object, a system user needs to review the populated image/landscape at key points over time. These key points are referred to as “memory milestones.”
Memory Object: A “memory object” is each individual item from a memory list that a system user wants to memorize. A memory object may include, for example, a number, a name, a story, an image and/or a related link.
Memory Object Number: Each memory object contains a number that can be used to sequence the memory objects throughout an image/landscape.
Memory Points: By utilizing the disclosed system/method, a system user can earn “memory points.” Memory Points are earned when a system user tests himself/herself on a populated image/landscape, e.g., at specified memory milestones.
Memory Story: A “memory story” is a fanciful story that may be used to provide a cue to remembering a specific memory object. The memory story generally includes an intense visual key that gets incorporated with the memory object. For example, the memory story may be slightly wild and may bring a smile to the system user's face when he/she thinks about it.
Mind Palace: As used herein, the term “Mind Palace” refers to an advantageous way of remembering any type of information that can be listed. Each populated image/landscape associated with a system user's “Mind Palace” serves as a mental structure into which a system user can place things he/she wants to remember so that the individual can mentally stroll through his/her “Mind Palace” in the future to recall the list of items. “Mind Palace” is also a trademark/service mark of the applicant.
Room: A “room” is a space within a “Mind Palace” within which a system user can include a plurality of memory objects, e.g., up to ten memory objects. Generally, each memory object is superimposed on top of, adjacent to, or otherwise in association with a physical item, location or feature in the room as part of a landscaped image/landscape.

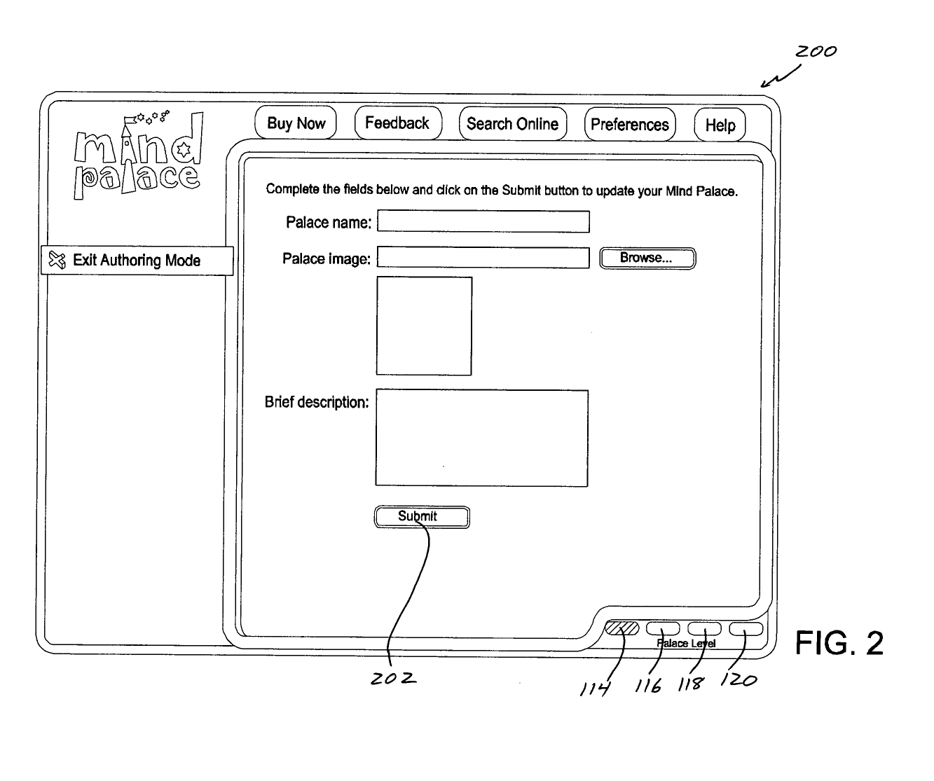

In an exemplary operation of the disclosed system/method, a system user arriving at the exemplary screen view 100 of FIG. 1 may, inter alia, elect to “Build Mind Palace” (i.e., select link 140 on the left side 130 of screen view 100) or select one of the icons displayed on the landscaped background, i.e., icons 122-128. If the “Build Mind Palace” link 140 is selected, the system user enters an “authoring mode” wherein a series of templates are provided for developing a populated image/landscape. An exemplary “authoring mode” template screen 200 is shown in FIG. 2. As shown on the exemplary template screen 200 of FIG. 2, a system user is generally given the opportunity to identify the “Palace Name,” “Palace Image” (i.e., image/landscape to be associated with the Palace that is being authored), and “Brief Description.” After completing the template, the system user may select the “Submit” button 202, which causes the relevant information to be stored in computer memory. Typically, the information is associated with and retrievable by the “Palace Name” selected by the system user.

Once an image/landscape is generated in the “authoring mode,” a link to such authored image/landscape is generally displayed against the landscaped background of FIG. 1. As noted previously, the link generally includes a thumb-nail icon associated with the authored image/landscape and a relevant title.

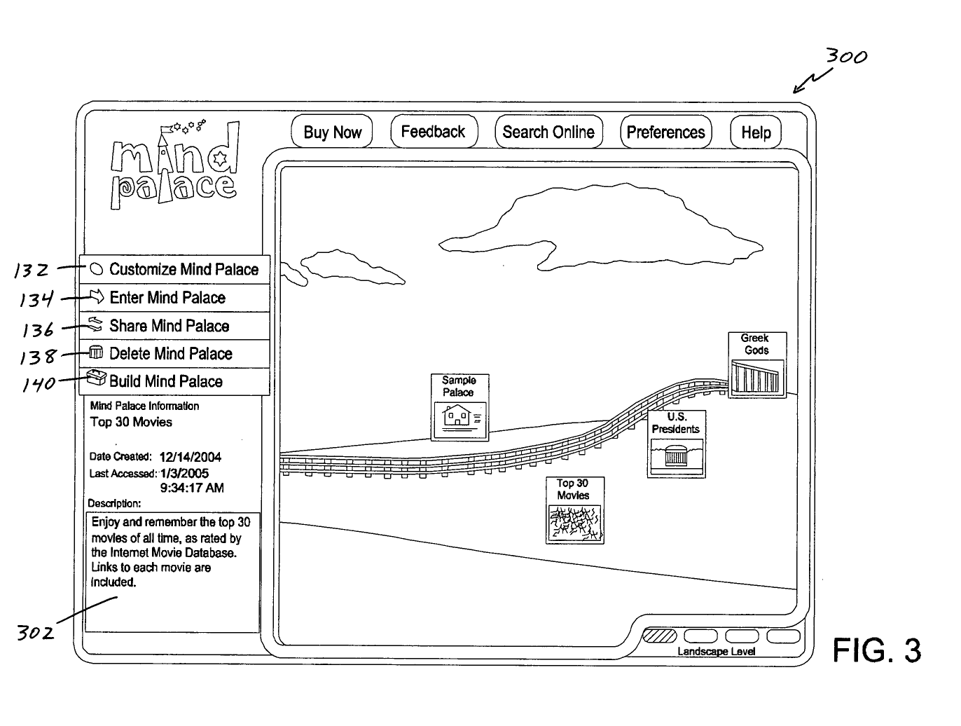

With further reference to FIG. 1, beyond the authoring mode described above, a system user generally interacts with the disclosed system/method by selecting one of the Mind Palaces that is displayed against the landscaped background 112. For example, a system user may select the “Top 30 Movies” icon 124 to access/interact with a first Mind Palace according to the present disclosure. As shown in FIG. 3 and with reference to exemplary screen 300, once a system user selects the “Top 30 Movies” icon 124 (single click), a series of navigational links along the left edge of the screen become active, i.e., Customize Mind Palace link 132, Enter Mind Palace link 134, Share Mind Palace link 136, Delete Mind Palace link 138, and Build Mind Palace link 140. In addition, basic information concerning the “Top 30 Movies” Palace appears in information block 302 in the left hand column of the exemplary screen. This basic information typically corresponds to descriptive information entered on an authoring template (see FIG. 2) and editing/authoring information, e.g., “date created” and “last accessed” information.

With further reference to the navigational links along the left column of screen view 300 of FIG. 3, the Build Mind Palace link 140 typically takes a system user to the “authoring mode” discussed herein above. Thus, a system user that selects the Build Mind Palace link 140 is typically presented with a screen view that includes a template for collecting relevant information associated with the “Mind Palace,” e.g., the template of FIG. 2. The Delete Mind Palace link 138 typically deletes/eliminates the selected “Mind Palace,” i.e., for purposes of FIG. 3, the “Top 30 Movies” Palace. Generally, a confirmation message is displayed in response to selection of the Delete Mind Palace link 138, i.e., to confirm a system user's desire/intent to delete the Mind Palace. If the user confirms his/her intention to delete the Mind Palace, the disclosed system removes the Mind Palace from the system user's “launch screen,” i.e., exemplary screen view 100 of FIG. 1, and further access to the deleted Mind Palace is generally not possible (absent back-up retrieval or the like).

With further reference to screen view 300 of FIG. 3, the Share Mind Palace link 136 generally allows a system user to make the selected Mind Palace (i.e., the “Top 30 Movies” Palace) available to other systems users, e.g., via a computer network or other communication mode. Thus, for example, selection of the Share Mind Palace link 136 may advantageously launch a web browser and effect an automatic navigational link to a website/URL that supports sharing of Mind Palaces, e.g., a library of available Mind Palaces. As noted above, contribution of a Mind Palace to an interactive library of Mind Palaces may be associated with applicable terms of use, e.g., an earn-out associated with third party use of a contributed Mind Palace(s). A contributed Mind Palace may be “uploaded” to the website supporting Mind Palace sharing functionalities and/or may be available to third parties through conventional peer-to-peer functionalities. A system user may return to the navigational screen 300 of FIG. 3 (which corresponds to a first level of the disclosed system/method), e.g., by closing and/or minimizing the browser functionality that was launched by way of the Share Mind Palace link 136.

Returning to the navigational links along the left side of the exemplary screen view 300 of FIG. 3, the Customize Mind Palace link 132 provides a system user with access to the “authoring mode” discussed above with reference to FIG. 2.

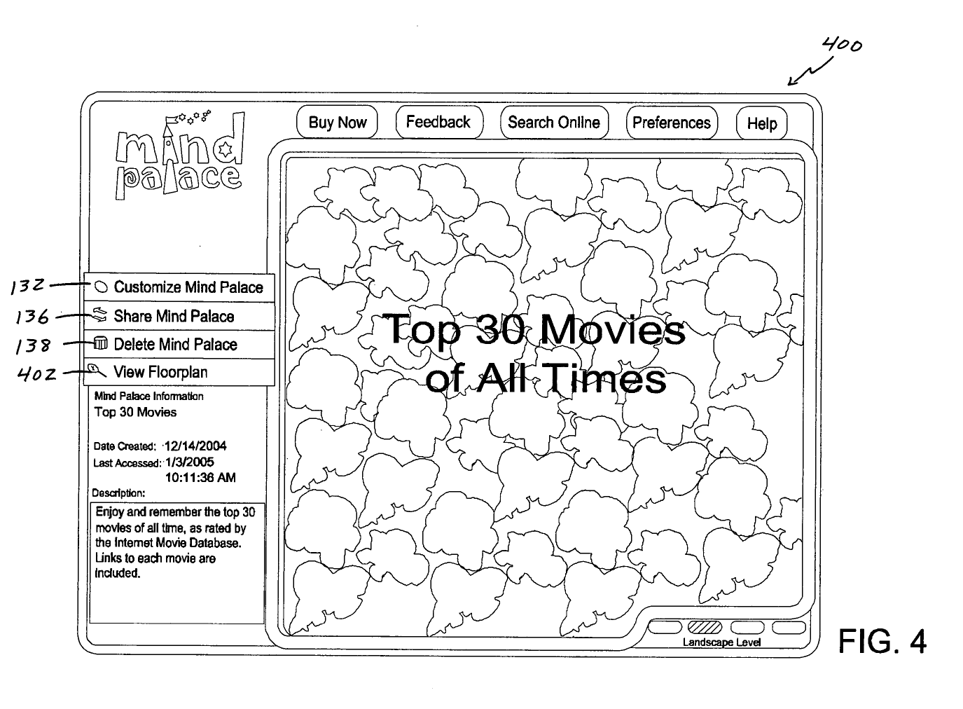

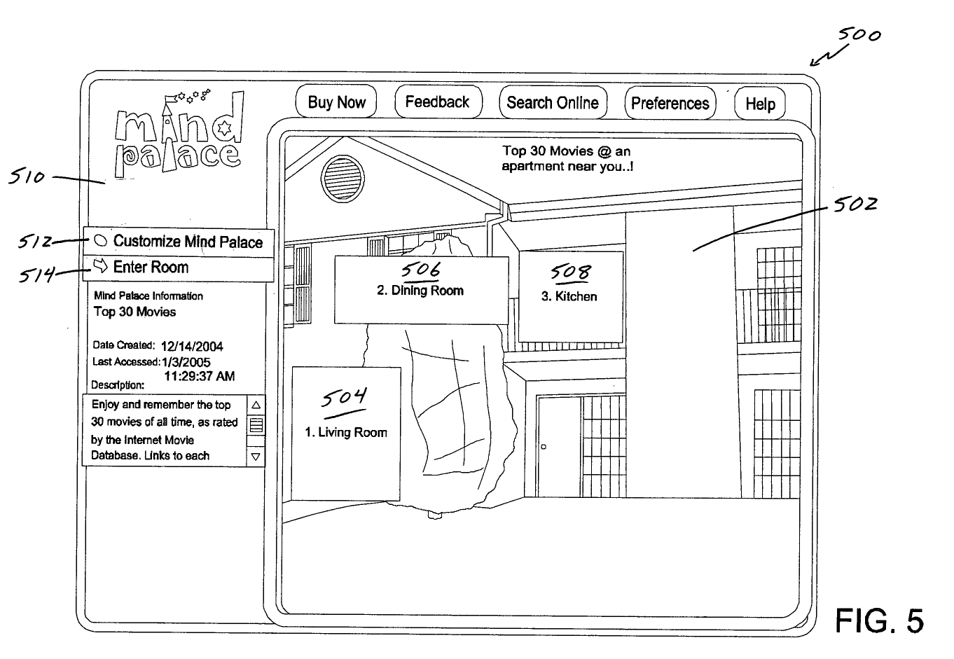

The fifth link on the left side of the exemplary screen of FIG. 3-i.e., the Enter Mind Palace link 134-provides access to a series of advantageous aspects of the present disclosure. As shown in the exemplary screen view 400 of FIG. 4, the Enter Mind Palace link 134 typically takes a user to the “second level” of the disclosed system/method. At this level, three of the previous links remain available, namely Customize Mind Palace link 132, Share Mind Palace link 136, and Delete Mind Palace link 138. The operations of these three links are generally unchanged relative to the previous descriptions. A fourth link is provided along the left side of the exemplary screen 400 of FIG. 4, namely a View Floor-plan link 402-which takes a system user to the floor-plan for the “Top 30 Movies” Palace, as shown in FIG. 5.

With particular reference to the exemplary screen view 500 of FIG. 5, a background image 502 is displayed as part of exemplary screen view 500, i.e., a two story residential building. This background image/landscape 502 may be selected by the system user, and may be changed/modified as desired by such user. According to exemplary embodiments of the present disclosure, predefined background images may be provided with one or more predefined Palaces, and the system user may maintain/utilize such predefined background image(s) or substitute image(s) of his/her choosing. Thus, for example, the residential building may be replaced by a structure of particular interest or familiarity to the system user, e.g., a childhood home, a beach house, an automobile, a map, etc. The possibilities for potential images to be used according to the present disclosure are limitless.

With further reference to FIG. 5, a plurality of icons/links (i.e., three icons) are displayed on the background image (residential building 502), each of which corresponds to an exemplary floor-plan associated with the exemplary “Top 30 Movies” Palace of the present disclosure. The three icons/links (Living Room link 504, Dining Room link 506 and Kitchen link 508) are generally defined by a system user. However, in predefined palaces that may be supplied with the disclosed system/method and/or accessed from a library of predefined Palaces, the floor-plans and associated icons/links may be pre-established and positioned on the background image (e.g., as shown in FIG. 5).

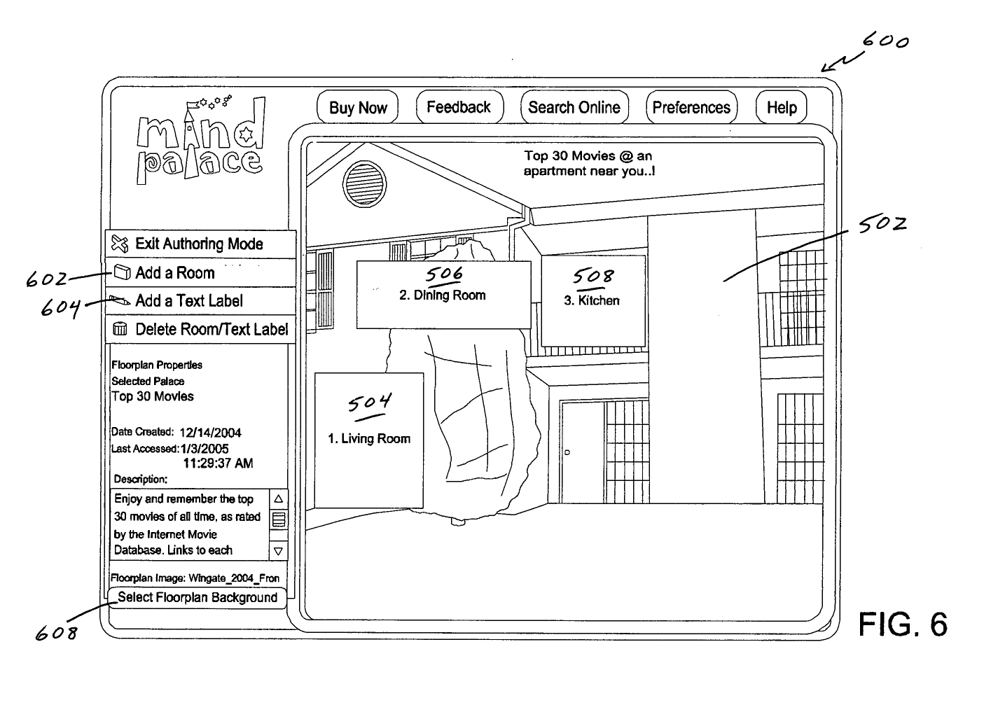

A pair of links are provided toward the top of the left side 510 of the exemplary screen view 500 of FIG. 5, namely Customize Mind Palace link 512 and Enter Room link 514. The Customize Mind Palace link 512 takes a user into “authoring mode,” but at a different authoring level. Thus, as shown in the exemplary screen view 600 of FIG. 6, selection of the Customize Mind Palace link 512 provides a system user with the ability to customize the icons/images of FIG. 5. Thus, the system user may elect to employ the Add a Room link 602 and/or the Add a Text Label link 604 in connection with an existing room. The “Add a Room” option permits a system user to add one or more additional rooms to the Mind Palace, e.g., a Bathroom, Bedroom, etc. Each of the additional rooms provides the system user with an opportunity to populate the disclosed system with additional information kernels/memory objects. In addition, the system user has the ability to upload and/or import desired images to the additional room(s), e.g., a digital image of his/her bedroom, etc. Thus, the disclosed system/method allows system users to gain/enhance memory skills through interaction with familiar images/room layouts/objects.

Of note, the Add a Room link 602 generally adds an icon to the existing background image (i.e., the residential building 502), and through drag-and-drop functionality, the system user is able to relocate the icon on the background image. Data entry boxes and/or drop down menus allow the system user to “name” the new room, select the color of the icon, import/link a digital image to the additional room, and provide a personalized description of the room. Failure to import/link an image to the newly added room will prevent a system user from populating the room with information kernels/memory objects. The size of the icon is generally adjustable through conventional means, e.g., drag-and-drop functionalities associated with the outer border of the geometric shape.

The “Add a Text Label” functionality operates in a similar manner to the “Add A Room” functionality described above. Thus, a system user may select the Add a Text Label link 604 and enter verbiage (i.e., a text label) that will then appear on the landscaped background, e.g., the residential building 502 of FIGS. 5 and 6. The textual image may take a variety of forms, e.g., words of encouragement, instructional guidance, etc. In the exemplary screen view 600 of FIG. 6, a text label 606 is included in the sky above the residential building (“Top 30 Movies@ an apartment near you . . !”) The positioning of the text label 606 may be modified by conventional drag-and-drop functionality.

Toward the bottom of the left side of the exemplary screen view 600 of FIG. 6, a system user is also given the opportunity to employ a Select Floorplan Background link 608, i.e., substitute a different background image for the residential building 502 shown in FIGS. 5 and 6. By selecting the Select Floorplan Background link 608, the system user generally has the ability to select an image from multiple sources, e.g., from images available on the Internet, from his/her personal images, and/or from a library of images offered/maintained by an operator of the disclosed system/method. In any case, the disclosed system/method offers tremendous flexibility/versatility to system users in terms of images to be associated with all “levels” of the disclosed system/method.

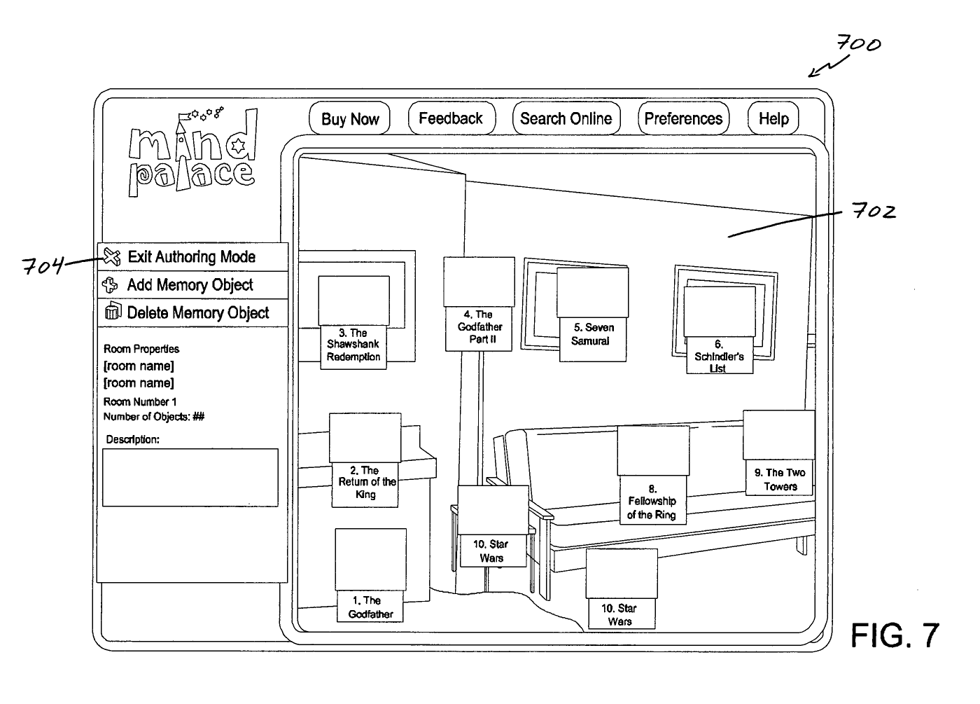

With further reference to FIG. 6, a system user may continue in the “customization” authoring mode by selecting an icon link associated with any of the individual rooms laid out on the background image 502, i.e., the Living Room link 504, the Dining Room link 506 and/or the Kitchen link 508. With reference to exemplary screen view 700 of FIG. 7, an exemplary Living Room 702 (that may be accessed by selecting the Living Room icon 504) is depicted. Of note, the “room” view represents the fourth level according to an exemplary embodiment of the present disclosure, i.e., the furthest navigational level associated with the disclosed system/method. In the exemplary screen view 700 of FIG. 7, the Living Room 702 is populated with ten memory objects that are generally positioned in association with objects and/or room locations. Thus, memory object #8 (“Fellowship of the Rings” ) is associated with the centrally positioned couch. Of note, in the exemplary view 700 of FIG. 7, the substantially opaque white rectangles that appear above each numbered memory object are substantially transparent when viewed on a computer monitor, such that the objects/images positioned therebehind are visible to a system user.

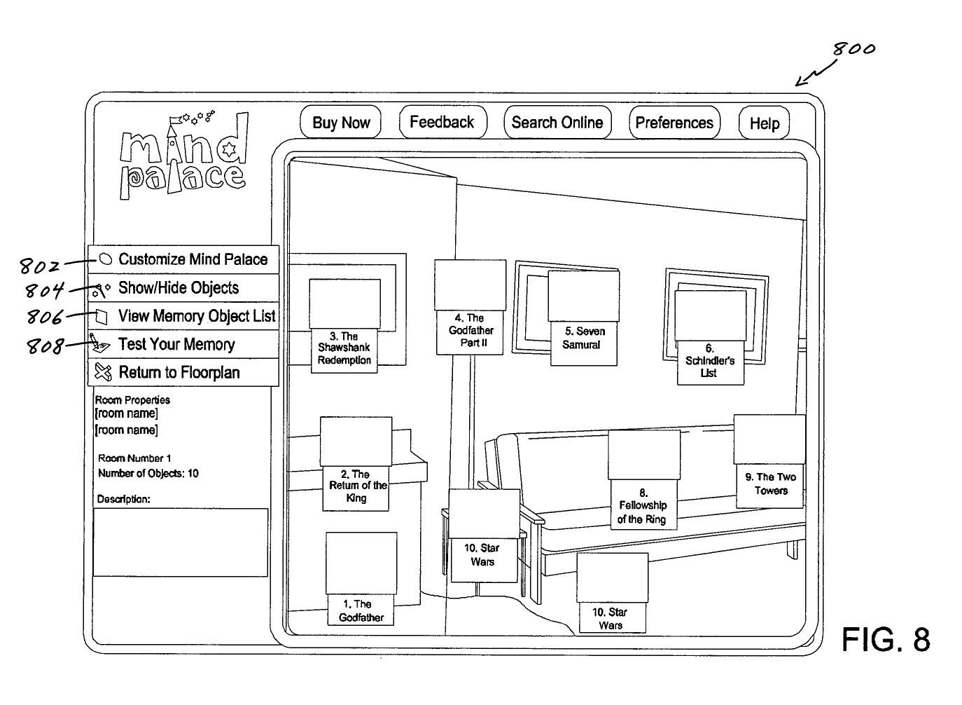

In the customization/authoring mode, a system user is able to add/delete memory objects, reposition memory objects, edit the memory objects themselves (i.e., the movie name), and/or enter/modify a “memory story” that is designed/intended to assist a system user in recalling/memorizing the memory object. Thus, with reference to FIG. 8, an exemplary screen view 800 for customization of memory object #8 is depicted. A system user has the ability to renumber the memory object (currently #8), rename the memory object (currently “Fellowship of the Rings”), revise the memory story (currently “Bilbo sits on the couch, smoking a pipe and [celebrating his 111th birthday]), and/or add a memory object image and/or related network-based information.

The process of populating a room with memory objects, positioning the memory objects relative to objects and/or locations in the room, and creating memory stories that connect with the memory object and/or the object/location to which the memory object is associated, are useful tools in developing memory skills and/or committing these specific memory objects to memory. In particular, the memory stories and the room's objects/locations offer the system user with an opportunity to create unique and memorable associations that will stick in the memory of the system user for a long period. Then, when attempting to recall the memory object, the system user can mentally tour the room, recalling the memory object/memory story as each object/location is encountered. By selecting a room or location that will be visited in day-to-day life, the system user potentially increases the likelihood that he/she will review the memory stories and the associated memory objects in his/her mind.

With further reference to exemplary screen view 700 of FIG. 7, by selecting the Exit Authoring Mode link 704, a system user is presented with a series of additional options for interacting with the disclosed system/method. As shown in screen view 800 of FIG. 8, the system user can reenter the authoring mode by selecting the Customize Mind Palace link 802, e.g., if he/she desires to revise the memory objects, memory stories, etc. Alternatively, the system user can select the Show/Hide Objects link 804 which toggles between the image 800 of FIG. 8 (where the memory objects are shown) and an alternative view wherein the memory objects are not visible (which leaves the living room unobstructed). This latter view is advantageous for practicing memory skills, i.e., pre-testing whether the system user has mastered the memory stories/memory objects based on a review of the objects/locations in a room.

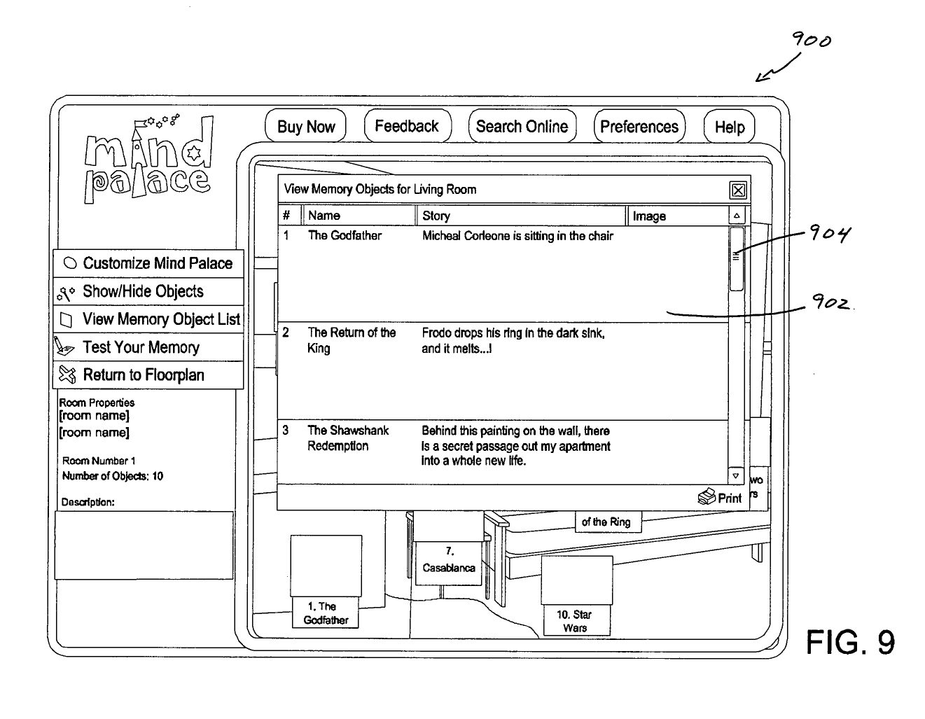

In addition, the system user can select the View Memory Object List link 806 which, as shown in exemplary screen view 900 of FIG. 9, provides an inset 902 to the “living room” view of FIG. 8. According to an exemplary embodiment of the present disclosure, the inset 902 provides a three or four column view of information relevant to the memory objects that populate the living room. In particular, the tabular inset 902 shows the object #, object name, memory story and image (if any). A vertical navigation bar 904 on the right side of the inset 902 allows the user to move up/down on the inset 902 to view its entirety. The View Memory Object List link 806 thus provides a system user with a useful review tool for memorization purposes.

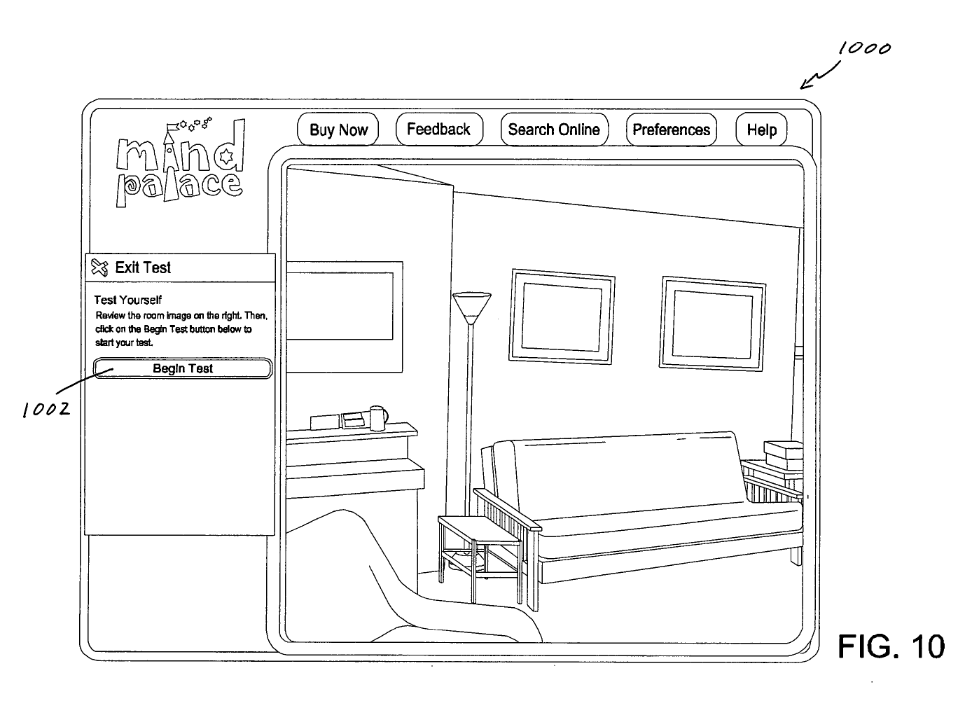

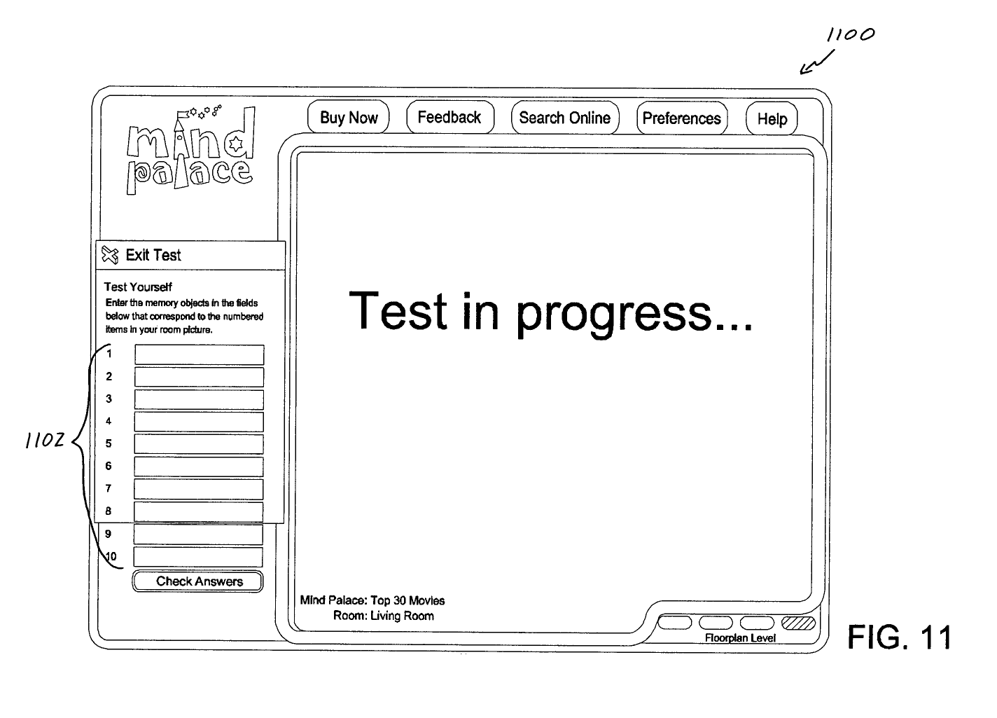

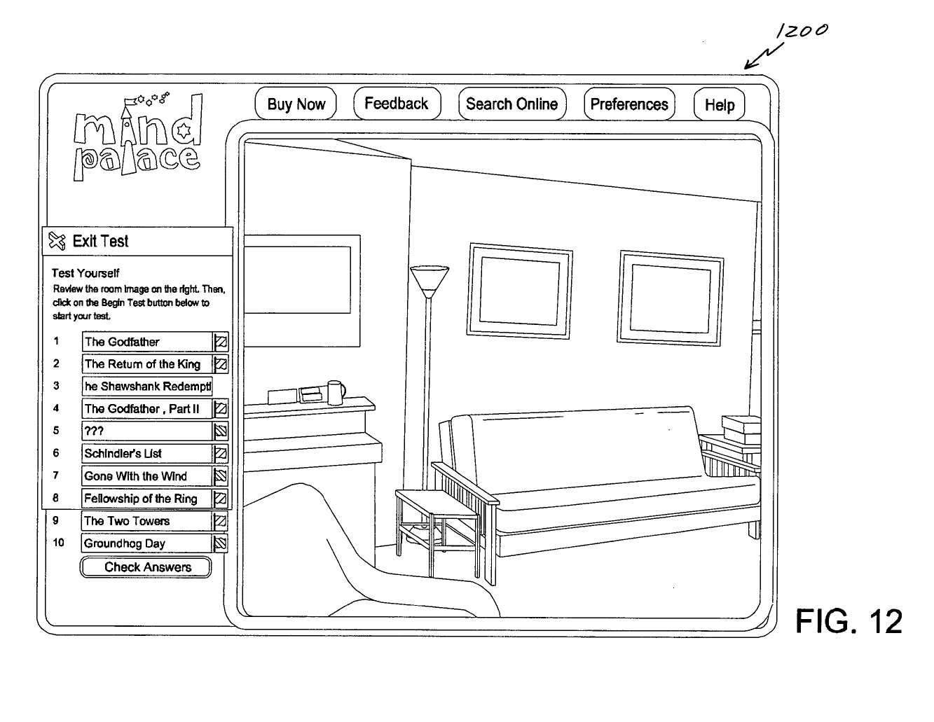

Returning to FIG. 8, the Test Your Memory link 808 offers the system user with an opportunity to test his/her memorization of the memory objects that populate the floor-plan/room. According to exemplary embodiments of the present disclosure, selection of the Test Your Memory link 808 initially removes the memory objects from the room, but leaves the room's image available for last minute review (see screen view 1000 of FIG. 10). Thereafter, when the system user selects the Begin Test link 1002 on exemplary screen view 1000, the image of the room is obscured, as shown in exemplary screen view 1100 of FIG. 11. The system user is provided with an “answer sheet” 1102 for entry of his/her recollections of the memory objects that populate the room (see FIG. 11). Of note, the test may be timed to provide a further element/parameter for the system user's performance. After the system user has completed the test, the disclosed system/method automatically checks the accuracy of the answers and provides a report of correct/incorrect answers (see screen view 1200 of FIG. 12). In the illustrative view of FIG. 12, the system user correctly identified seven out of ten memory objects.

The disclosed system/method advantageously includes functionality for storing test results/performance. Accordingly to exemplary embodiments of the present disclosure, various parameters associated with the test results are also collected by the system/method and incorporated into the test storing functionality, e.g., date of test, number of days from creation of populated room (e.g., second day, fifth day, etc.), test taking time, and overall performance. A system user's performance may be viewed in a variety of formats, e.g., tabular, bar graph, etc., and may be presented relative to other system users and/or “norms” of performance. Indeed, competitive environments may be established according to exemplary embodiments of the present disclosure, e.g., a student body at a particular school, in a particular class or at a particular grade level. Indeed, the disclosed system/method may provide a weighted memory testing algorithm that tests and scores users over a multi-year period, posting scores in a gaming like environment.

According to exemplary embodiments of the present disclosure, system users are prompted to review populated rooms/Memory Palaces at predetermined intervals, and to take tests with respect to the memory objects located therein at predetermined intervals. The prompting functionality may be based on network communications, e.g., e-mail, or may be automatically prompted through an internal clock associated with the system user's hard drive at predetermined time intervals. By prompting a system user to review and/or re-test his/her memory, enhanced memory performance may be advantageously achieved for such system user.

As will be readily apparent to persons skilled in the art, the system and method of the present disclosure may be implemented in a variety of advantageous ways. The disclosed system/method offers users with a tremendous tool for enhancing/refining memory skills by associating memory objects and memory stories with a room (or other landscape/image), and recalling the memory objects/memory stories by imagining a visit to the populated location. As the system user imagines encountering the various objects/locations in the selected location, he/she is prompted to recall the memory stories/memory objects that he/she has associated therewith.

Although the present disclosure describes exemplary embodiments of the present disclosure with reference to illustrative embodiments hereof, the present disclosure is not limited to such exemplary embodiments. Rather, the present disclosure extends to alternative implementations and/or applications of the disclosed systems and methods.

1. A computer-based system for enhancing memory skills, comprising:
(a) a processor that communicates with computer memory,
(b) a program adapted to operate on said processor; said program being adapted to:
i. provide an image that functions as a background; and
ii. associate one or more memory objects with the image.

2. A computer-based system according to claim 1, wherein the image is predefined by the program.

3. A computer-based system according to claim 1, wherein the image is input or imported to the program from an external location.

4. A computer-based system according to claim 3, wherein the image is imported from a library of images.

5. A computer-based system according to claim 4, wherein the program is further adapted to calculate a payment amount based on import of an image from an image library.

6. A computer-based system according to claim 4, wherein the program is further adapted to calculate a payment amount based on export of an image to an image library.

7. A computer-based system according to claim 3, wherein the image is a digitized image created by a system user.

8. A computer-based system according to claim 1, wherein the program is further adapted to support memory testing based on the one or more memory objects associated with the image.

9. A computer-based system according to claim 1, wherein the program is further adapted to generate a reminder communication related to at least one next step at a predetermined time period.

10. A computer-based system according to claim 8, wherein the at least one next step is testing.

11. A computer-based system according to claim 8, wherein the at least one next step is review.

12. A computer-based system according to claim 1, wherein the program is further adapted to associate a plurality of rooms with a single image.

13. A computer-based system according to claim 1, wherein the program is further adapted to permit a system user to input one or more memory objects, memory stories, or ancillary information for association with the image.

14. A computer-based system according to claim 1, wherein each of said one or more memory objects is associated with a memory story.

15. A computer-based system according to claim 1, wherein each of said one or more memory objects is associated with an object or location visible in the image.

16. A method for enhancing memory skills, comprising:
(a) associating one or more memory objects with an image that is displayed by a computer-based system,
(b) providing a computer-based test of the memory objects associated with the image.

17. A method according to claim 16, further comprising associating the one or memory objects with a memory story.

18. A method according to claim 16, further comprising selecting an image for display by the computer-based system.

19. A method according to claim 18, wherein the image is selected from an image library.

20. A method according to claim 16, further comprising providing periodic reminders with regard to the computer-based test.
